(19) United States
(12) Patent Application Publication
(10) Pub. No.: US 2013/0024251 A1
(43) Pub. Date: Jan. 24, 2013

(54) COMMUNICATING PRESENTATION DATA RELATING TO PRESENTATION OF INFORMATION

(71) Applicants: Bruno Richard PREISS, Waterloo (CA); David Rene PROULX, Waterloo (CA); William John GUNTON, Unionville (CA)

(72) Inventors: Bruno Richard PREISS, Waterloo (CA); David Rene PROULX, Waterloo (CA); William John GUNTON, Unionville (CA)

(21) Appl. No.: 13/188,541

(22) Filed: Jul. 22, 2011

(51) Int. Cl. G06F 3/01; G06Q 30/00

(52) U.S. Cl. 705/14.4; 705/34; 715/730

(57) ABSTRACT

Presentation data related to presentation of information at an electronic device is provided, where the presentation data includes an indicator of a zoom level at which the information was presented. An effectiveness measure relating to an analysis of the presentation data can be derived to indicate an effectiveness of the presented information.

### BACKGROUND

Electronic devices can receive information to be presented to users. Examples of such information include web pages as well as other information. The information to be presented at electronic devices can be communicated to the electronic devices over wired or wireless networks (or both). In some cases, the information communicated to the electronic devices can include advertisements, such as advertisements presented as part of web pages.

### BRIEF DESCRIPTION OF THE DRAWINGS

Some embodiments are described with respect to the following figures:

FIG. 1 is a block diagram of an example arrangement including an electronic device and an analysis device, in accordance with some embodiments;

FIG. 2 is a flow diagram of a process of performing presentation data analysis, according to some embodiments;

FIG. 3 is a block diagram of another example arrangement including electronic devices and various servers, according to further embodiments;

FIGS. 4A-4C illustrate example displays of presented information, according to some examples;

FIG. 5 is a flow diagram of a process of providing presentation data for presented information at an electronic device, according to some embodiments;

FIG. 6 is a flow diagram of a process of an information server, according to further embodiments;

FIGS. 7 and 8 are data flow diagrams illustrating communications among various nodes, according to various embodiments; and

FIG. 9 is a block diagram of an example system capable of incorporating some embodiments.

### DETAILED DESCRIPTION

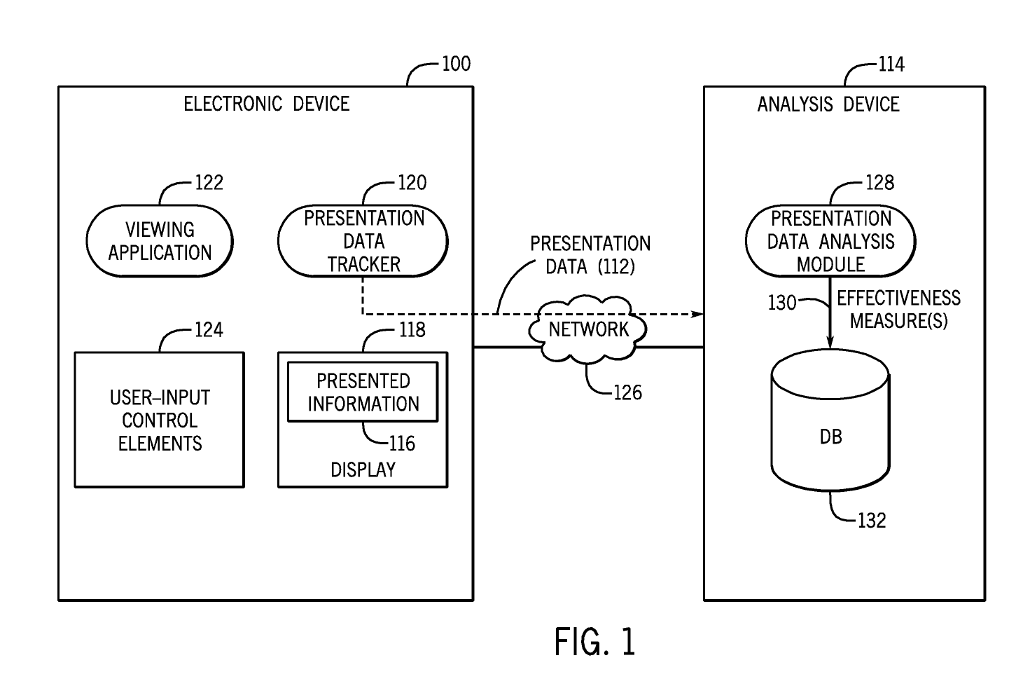

Referring to FIG. 1, techniques or mechanisms according to some embodiments allow presentation data 112 relating to presentation (e.g. display) of information at an electronic device 100 to be gathered and communicated to an analysis device 114 for determining an effectiveness of the presented information 116. Examples of the electronic device 100 include a personal digital assistant (PDA), a mobile telephone, a smart phone, a notebook computer, a tablet computer, or any other type of electronic device.

The presented information 116 can be displayed by a display 118 of the electronic device 100. In some examples, the presented information 116 includes advertisement information. In other examples, the presented information can include other types of information, such as a web page, online help information, and so forth.

The “effectiveness” of the presented information 116 pertains to how interesting, useful, important, attractive, or impressive the presented information was to a user of the electronic device 100. Users may find certain information uninteresting or not useful—for example, users often quickly scroll away from advertisements that are contained in web pages. Without an understanding of how effective presented information (such as advertisement information) is to users, information providers may continue to cause ineffective information to be presented. Also, a lack of understanding of the effectiveness of presented information may prevent the ability to appropriately bill for presentation of information—for example, web content providers can charge higher amounts for advertisements that were more effective and charge lower amounts for advertisements that were less effective.

The presentation data 112 gathered at the electronic device 100 contains indicators that relate to presentation of the information at the electronic device 100, where the presentation can be controlled by actions of the user or can be controlled automatically by the electronic device, or both.

A presentation data tracker 120 in the electronic device 100 tracks data related to the presentation of the information 116. Such tracking allows various indicators to be produced and included in the presentation data 112. In some examples, the indicators include one or more of the following: an indicator of a zoom level at which the information is viewed, an indicator of a location of the information on a display of the electronic device, an indicator relating to a length of time during which the information is being presented, an indicator relating to how much of the display of the electronic device is presenting the information, an indicator relating to how much of the information is being presented on the display, an indicator of rendered resolution (a number of pixels of the information shown), an indicator of the displayable resolution (a number of pixels of the information that could be shown in the display), and so forth.

An “indicator” refers to data describing a characteristic or characteristics of interest, such as any of the characteristics noted above relating to presentation of information at the electronic device. Although various indicators are listed above, note that in alternative implementations, alternative or additional indicators may be included in the presentation data that is to be sent to an analysis device. More generally, “presentation data” refers to any metric or combination of metrics associated with presentation of information at an electronic device.

The indicator relating to a length of time during which the information is being presented may be combined with the zoom level indicator to indicate any one or more of: how long the information was presented at a zoom level, how long the information was presented at a location, and how long the information was presented. For example, the time and zoom level indicators together may indicate that information was displayed at a zoom level of 100% for 100 seconds, followed by the information being displayed at a zoom level of 200% for 20 seconds, and then followed by the information being displayed at a zoom level of 400% for 50 seconds.

Additionally, the indicators of the presentation data can indicate the following, as examples. The presentation data may indicate that 25% of the information is presented on 50% of the display for 100 seconds with the rendered resolution of the information being 20×100 pixels, then 50% of the information is presented on 25% of the display for 50 seconds with the rendered resolution of the information being 10×50 pixels, and so forth.

The zoom level of the presented information 116 may be controlled by a viewing application 122 (e.g. web browser or other viewing application) in response to user selection, such as using one or more of user-input control elements 124. The user-input control elements 124 can include one or more of the following: a text box control element containing a number specifying a zoom level; a list box control element that lists a number of possible zoom levels; button control elements that increase or decrease a zoom level based on which button is pushed; a slider control element wherein the position of a slider controls the zoom level; a menu control element; a touch-sensitive display control element (where tapping, swiping, etc., on the touch-sensitive display screen can be used to effect zoom control); and so forth. When the electronic device 100 detects activation of a user-input control element 124 that corresponds to a zoom action, the electronic device 100 adjusts the zoom level of the presented information 116 accordingly.

The user-input control elements 124 can also be used to scroll through the presented information 116 in the display 118, where the scrolling action can be an action to scroll up, scroll down, scroll left, scroll right, or scroll in any other direction. Scrolling in the displayable area of the display 118 can cause the presented information 116 to be fully visible in the displayable area, to be partially visible in the displayable area, or to be moved away from the displayable area such that a user can no longer view the presented information 116. The scrolling action affects the location of the presented information 116, and thus affects one or more of the indicators in the presentation data 112 output by the presentation data tracker 120 in the electronic device 100. Examples of user-input control elements 124 to effect scrolling include an up-down scroll slider, a left-right scroll slider, a touch-sensitive display control element (where a swiping, sliding, or other action on the touch-sensitive display screen causes scrolling), and so forth. When the electronic device 100 detects activation of a user-input control element 124 that corresponds to a scrolling action, the electronic device 100 may adjust the location of what is being displayed accordingly.

Additionally, the presentation data may include an indicator that a request for more content related to the presented information 116 was sent subsequent to presenting the information 116. For example, the information may be displayed as an advertisement on a web page that when accessed or clicked generates a request for more content related to the advertisement.

The presentation data 112 sent to the analysis device 114 over a network 126 can be analyzed by a presentation data analysis module 128 in the analysis device 114. The presentation data analysis module 128 can use any number of algorithms that relate to the presentation data to determine an effectiveness of the presented information. The effectiveness of the presented information can be indicated by an effectiveness measure (or multiple effectiveness measures) 130 output by the presentation data analysis module 128. Examples of effectiveness measures include a value of the presented information, a priority of the presented information, or some other effectiveness measure.

For example, when the presented information includes an advertisement that is part of a web page displayed on the electronic device 100, if the presentation data 112 indicates that the advertisement takes up a relatively large percentage or amount of the displayable area of the display 118 of the electronic device 110 and the advertisement was visible in the display 118 for a longer period of time, then the advertisement may be determined to be more effective, and can be assigned a higher value or a higher priority, or both, as compared to another advertisement that takes up a smaller amount of the displayable area and was visible for a shorter amount of time. As another example, if an advertisement is initially presented at a high zoom level and is quickly zoomed out from this high zoom level, then the analysis of the presentation data related to that advertisement may determine that the advertisement is less effective and thus assigned a lower effectiveness measure, such as in the form of a lower value or lower priority.

In addition to the effectiveness measure(s) 130, the presentation data analysis module 128 can further output other analysis data. As examples, the analysis data may include a percentage related to the amount of the display 112 that displays the information, calculated by dividing the rendered resolution of the information by the screen resolution of the display 112. The analysis data may also include a percentage related to how much of the information is displayed, calculated by dividing the rendered resolution of the information by the displayable resolution of the information.

The effective measure(s) 130 and the analysis data may be stored in a single database 132 or in multiple databases related to a corresponding plurality of electronic devices. In some examples, the presentation data 112 received by the analysis device 114 can also be stored in the database(s) 132. In some examples, the data stored in a single database can be associated with identifiers of electronic devices to which the stored data relates. Alternatively, the presentation data analysis module 128 can store the presentation data and effectiveness measures in individual databases for respective ones of different electronic devices. In some examples, the data in the database(s) 132 may be deleted after a predefined period of time. For example, data stored in the database 132 that is more than three (or some other number of) days old may no longer be relevant and thus can be deleted.

The effectiveness measure(s) 130 provided by the presentation data analysis module 128 in the analysis device 114 based on analysis of the presentation data 112 can be used for various purposes, such as billing, selection of which of multiple information (e.g. which of multiple advertisements) to present in the future, and so forth. For example, web content providers can charge advertisers different amounts depending on the effective measure(s) 130. As a more specific example, when analysis of presentation data indicates that particular information is viewed at a higher zoom level for a longer period of time, then the presentation of the particular information may be charged at a higher amount than information that is viewed at a lower zoom level for a shorter period of time. This may be because an advertiser that pays for the information to be presented is willing to pay more for information found by users to be more interesting (as indicated by viewing of the information at a higher zoom levels for longer periods of time).

Although the presentation data analysis module 128 is depicted as being part of the analysis device 114 that is separate from the electronic device 100 in the arrangement of FIG. 1, note that in alternative implementations, the presentation data analysis module 128 can be part of the electronic device 100. In such implementations, in addition to the presentation data 112 sent by the electronic device 100, the electronic device 100 can also send effectiveness measure(s) 130 as discussed above. In such implementations, the analysis device 114 can use the effectiveness measure(s) 130 from the electronic device 100 to perform further analysis.

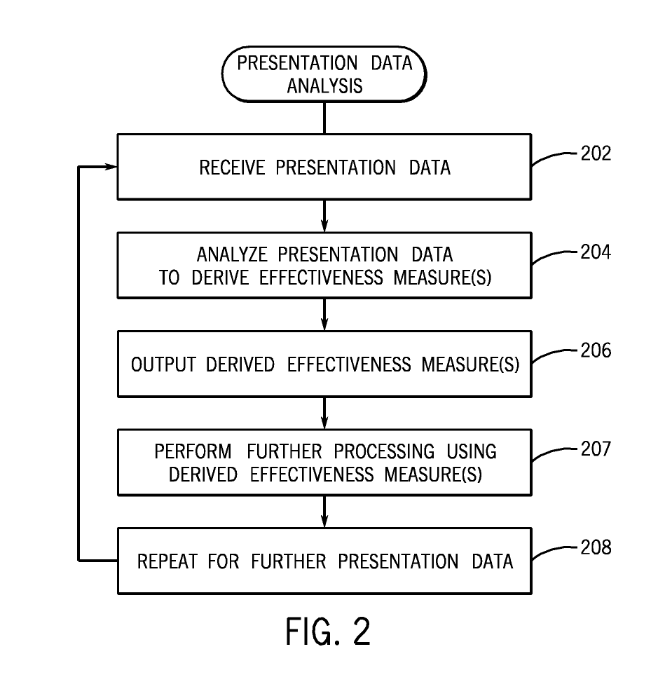

FIG. 2 is a flow diagram of a process of the presentation data analysis module 128 in the analysis device 114, in accordance with some implementations.

The presentation data analysis module 128 receives (at 202) presentation data from an electronic device (such as presentation data 112 from the electronic device 100 of FIG. 1). As noted above, the presentation data includes one or more of the indicators discussed above.

The presentation data analysis module 128 then analyzes (at 204) the presentation data to derive an effectiveness measure (or multiple effective measures) associated with presentation of the presented information at the electronic device from which the presentation data was received.

The presentation data analysis module 128 then outputs (at 206) the derived effectiveness measure(s). The output effectiveness measure(s) can be used internally at the analysis device 114, such as by another application in the analysis device 114, for further processing (at 207). Alternatively, outputting the effectiveness measure(s) refers to communicating the effectiveness measure(s) over a network to another system to allow further processing. In either case, the “further processing” based on the effectiveness measure(s) can include a determination of a rate or amount to charge for presentation of the presented information, selection of one of multiple information to send in the future, and so forth.

The process of FIG. 2 is repeated (at 208) for further presentation data received by the analysis device 114.

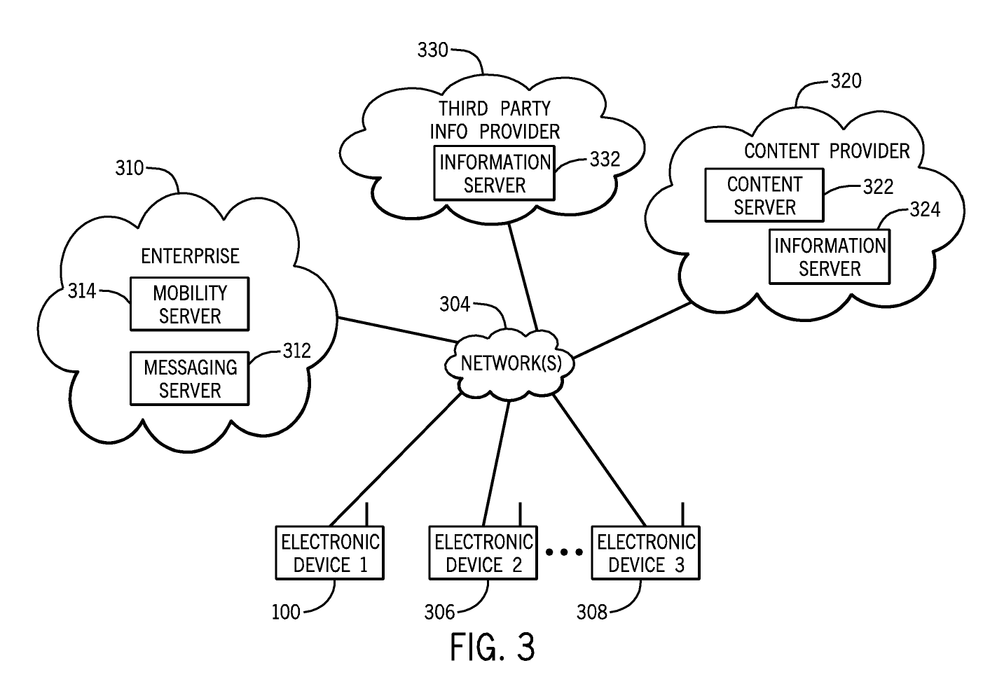

The analysis device 114 can be implemented as a server or some other type of system. FIG. 3 shows an example arrangement that includes one or more networks 304 interconnecting various different devices, including the electronic device 100 (of FIG. 1) as well as other electronic devices 306 and 308, which can be in the form of wireless devices (or wired devices). The electronic devices 100, 306, and 308 are able to communicate over the network(s) 304 with various servers that can be part of an enterprise 310, a third party information provider 330, and a content provider 320. Although specific nodes are depicted in FIG. 3, it is noted that in alternative examples, additional or alternative nodes can be provided. In other examples, one or both of the content provider 320 and information provider 330 can be part of a carrier network (such as a wireless carrier network that provides wireless access services to subscribers).

The third party information provider 330 can be an advertisement provider, for example, or a provider of another type of information. The third party information provider 330 includes an information server 332, which is able to cause information to be presented at any one of the electronic devices 100, 306, and 308. In some implementations, in addition to being able to cause presentation of information at selected electronic devices, the information server 332 can also include functionalities of the analysis device 114 of FIG. 1.

In alternative implementations, the functionalities of the analysis device 114 can be provided on a different node (instead of the information server 332). One such different node is a mobility server 314 in the enterprise 310, which is able to receive presentation data from an electronic device. The enterprise 310 further includes a messaging server 312 for providing messaging services. In such implementations, the mobility server 314 is able to analyze received presentation data and send corresponding derived effectiveness measure(s) to the information server 332 for further processing, for example. The information server 332 may in turn determine what information (e.g. advertisement) to send to the electronic devices 100, 306, 308 based on the effectiveness measure(s) the information server 332 receives from the mobility server 310.

In the example arrangement of FIG. 3, the content provider 320 includes a content server 322 and an information server 324. The content server 322 can provide requested content to the electronic devices 100, 306, 308 (e.g. requested web pages). The information server 324 can provide further information (in addition to the requested content from the content server 322). For example, the information from the information server 324 can include advertisement information. Alternatively, the content server 322 can receive further information from the information server 332 of the third party information provider 330, to be included in the requested content to be provided to the requesting electronic device.

The functionalities of the analysis device 114 of FIG. 1 can be provided in the content server 322 or information server 324, or both. Alternatively, the functionalities of the analysis device 114 can be provided in the mobility server 314 that is able to output derived effectiveness measure(s) to the content server 322 or information server 324, or both. As examples, the information server 324 can use the effectiveness measure(s) to decide what further information (e.g. advertisement) to send, and the content provider 322 can use the effectiveness measure(s) to decide a rate or amount to charge a provider (e.g. advertiser) of further information.

Although depicted as individual servers, each of the servers may include one or more servers, be part of a farm of servers, or be a part of a cloud of servers.

As an example of a communication flow, the electronic device 100 may send, via network(s) 304, a content request that is received by the content server 322. The content server 322 receives the request and sends a content response that is received by the electronic device 100. In addition to the content in the content response received from content server 322, the electronic device 100 may also receive further information (e.g. advertisement information) that is related to the content response from one or more of the information server 324 or 332. The electronic device 100 may then present the requested content and the further information on its display 112.

The connection between an electronic device and the content server 322 or an information server (332 or 324) may be a direct connection through the network(s) 304 or the connection may be an indirect connection. For example, an electronic device may first connect with the mobility server 314, wherein the mobility server 314 maintains a connection with the content server 322 or an information server. The network(s) 304 may be in the form of one or more wired or wireless networks that are according to various standards including Bluetooth, WiFi, 3GPP (Third Generation Partnership Project), LTE (Long Term Evolution), GSM (Global System for Mobile), Ethernet, and so forth.

The enterprise 310 may be an enterprise network site operated by a business or individual that includes one or more servers including the mobility server 314 and messaging server 312. The enterprise 310 may also include a content server (not shown) and an information server (not shown). The mobility server 314 provides mobility services that, among other things, provide for synchronization of email, calendar, and address book information between the messaging server 312 and the electronic devices 100, 306, and 308. The mobility server 314 may also provide information related to Internet browsing by the electronic devices 100, 306, and 308. For example, the mobility server 314 may cache the content from one or more content providers and the mobility server may also condense or compress the content from content providers so that less bandwidth is used to distribute the content from the content providers to the electronic devices.

The messaging server 312 provides messaging services that, among other things, provide for the sending and receiving of messages, storing of calendar information, and the storing of address book information. The messaging services provided by the messaging server 312 may be in the form of email, instant messaging, video conferencing, and so forth.

The content provider 320 provides content, which may include: content relating to navigational services; news or other information; web pages; documents, files, or applications; and so forth. The content server 322 may be a web server that sends content in the form of a web page in response to receiving a content request. The content may include information in the form of advertisements. One way to send such an advertisement is to include the advertisement with the content that is sent. Alternatively, the information or advertisement may be sent in the form of a link or reference so that the device that receives the content then requests the information or advertisement via the link or reference. The information or advertisements may come from the content provider 320 via the content server 322 and/or the information server 324, or the information or advertisements may come from the third party information provider 330 via the information server 332.

The content server 322 receives a content request for a web page from an electronic device. In determining what to send as a part of the content response, the content server 322 may send an information request to an information server (e.g. 332 or 324) for further information (e.g. advertisement information). The information server receives the information request and sends an information response to the content server 322 that includes, for example, the further information or a link to the further information. The content server 322 receives the information response and incorporates the information or link into the content response to send to the requesting electronic device.

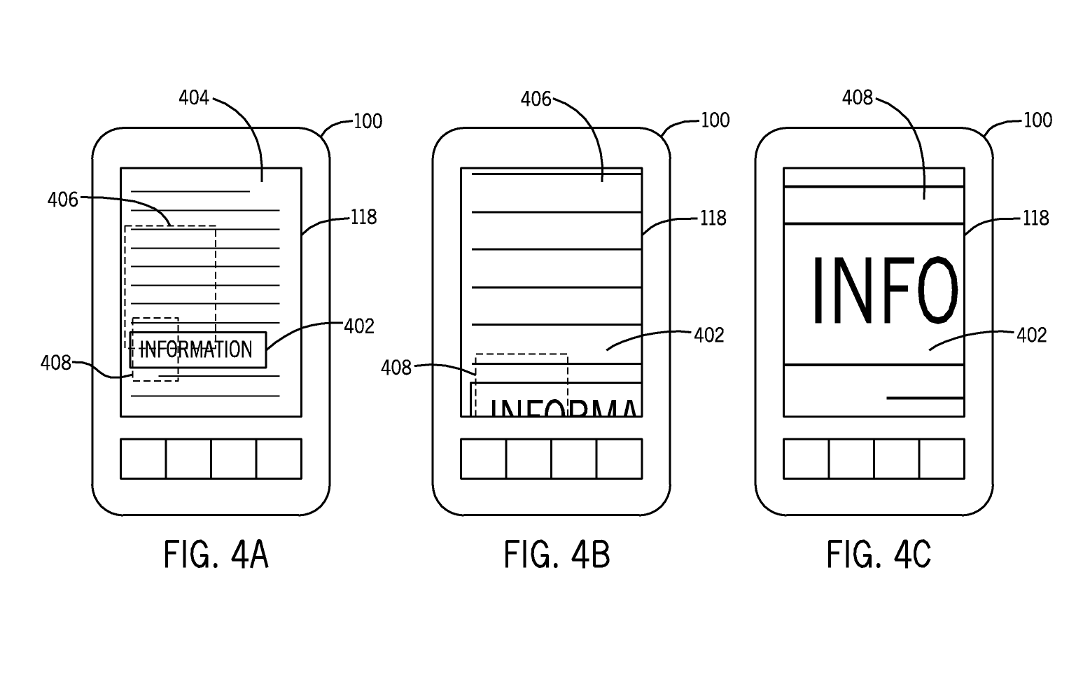

FIG. 4A, FIG. 4B, and FIG. 4C illustrate display of presented information 402, which may be an advertisement, at different zoom levels and at different locations within the display 118 of the electronic device 100. The presented information 402 can be presented within a portion 404 of a web page or a view of a viewing application. The electronic device 100 may also display other portions 406 and 408 of the web page, as shown in FIG. 4B and FIG. 4C, respectively, with the presented information 402 being at different zoom levels and different locations, such that the presented information 402 takes up different amounts of the display 118 and different amounts of the presented information 402 is displayed.

In FIG. 4A, all of the presented information 402 is displayed by the display 118 so that the rendered resolution—the amount of the information that is actually shown—of the presented information 402 is the same as the displayable resolution—the amount of the information that could be shown—of the presented information 402. In contrast, only a portion of the presented information 402 is displayed presented by the display 118 in FIG. 4B and FIG. 4C, so that the rendered resolution is less than the displayable resolution.

A rendered resolution of the presented information 402 is related to the amount of the information that is actually rendered in the display 118, and a displayable resolution of the information is related to the size information if it were fully rendered at the current zoom level and as such is based on the zoom level and location of the information. For example, the zoom level of FIG. 4A may be 100%; assuming that the displayable resolution of the presented information 402 is 20×100 pixels, since the entirety is shown, the rendered resolution is also 20×100 pixels. The zoom level of FIG. 4B may be 200% so that the displayable resolution of the presented information 402 is 40×200 pixels. However, as shown in FIG. 4B, the rendered resolution of the presented information 402 may be only 20×166 pixels, so that not all of the presented information 402 is being presented on the display 118. The zoom level of FIG. 4C may be 400% so that the displayable resolution of the information window 402 is 80×400 pixels; however, in FIG. 4C only half of the width of the presented information 402 is displayed. As such, the rendered resolution would be 80×200 pixels instead of the full displayable resolution of 80×400 pixels.

The rendered resolution and the displayable resolution may be tracked by the presentation data tracker 120 of the electronic device 100. Indicators of rendered resolution and the displayable resolution may be sent with the indicators of zoom level and location as a part of the presentation data sent by the electronic device 100. Alternatively, instead of or in addition to the rendered resolution indicator and the displayable resolution indicator, the following indicators can be included as part of the presentation data: an indicator relating to how much of the display of the electronic device is presenting the information, and an indicator relating to how much of the information is being presented on the display.

The indicators of rendered resolution and the displayable resolution may include the actual number of pixels or may be percentage values. An indicator for a displayable resolution may relate to the percentage of the maximum resolution of the display screen. For example, when a displayable resolution is 20×100 and the display has a maximum resolution of 200×150 the indicator may be 0.067, indicating that 6.7% of the display screen is presenting the information. Additionally, an indicator for a rendered resolution may relate to the percentage of the displayable resolution of the information. For example, when a rendered resolution is 20×166 pixels and a displayable resolution is 40×200, the indicator may be 0.415 indicating that 41.5% of the information is being displayed.

While the presented information 402 is illustrated as being displayed in a web page in FIG. 4A, FIG. 4B, and FIG. 4C, it is noted that applications other than web browsers may cause display of the presented information 402. For example, the presented information 402 may be presented by a gaming application, a calendar application, a media player application, a mapping application, a navigation application, and so forth.

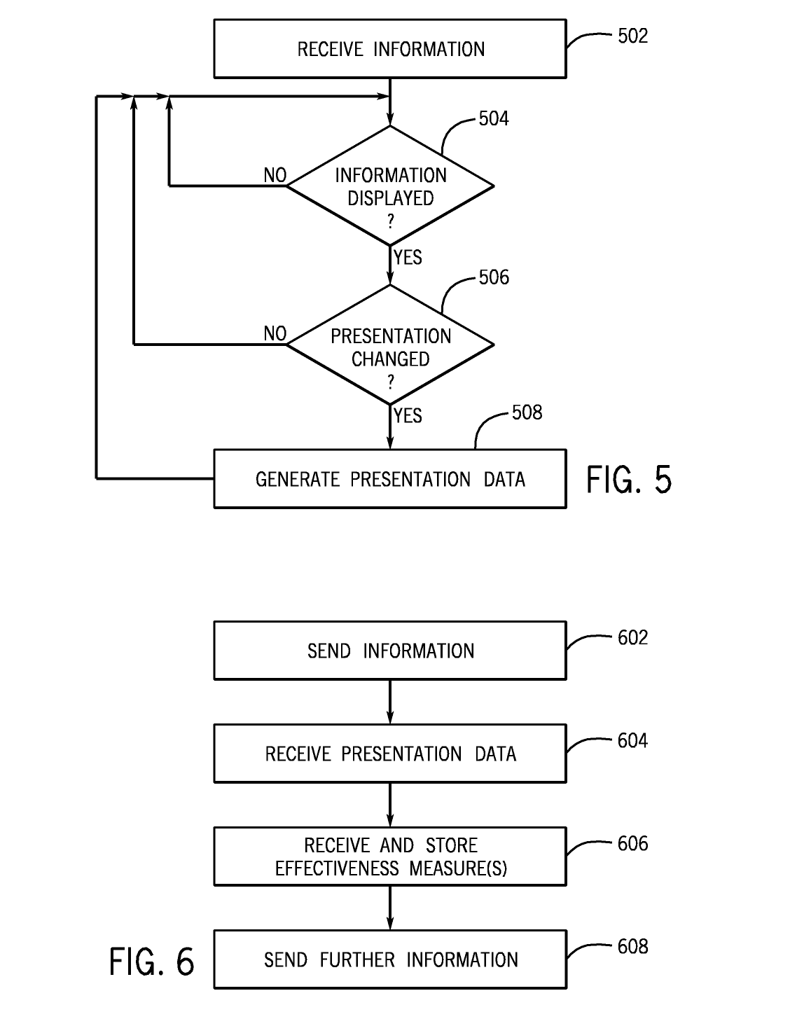

FIG. 5 is a flow diagram of a process of the electronic device 100, in accordance with some embodiments. The electronic device 100 receives (at 502) information, such as advertisement information or another type of information. The received information may include one or more of text, image, video, audio, and so forth. The received information may also include metadata that indicates where in other content (e.g. web page content) the received information is located.

The process next determines (at 504) whether the received information is displayed. The received information may or may not be initially displayed. For example, if the information is an advertisement on a web page, the advertisement may be displayed initially with the web page if the advertisement is located in certain parts of the displayed web page (e.g. in the upper portion of the web page).

If the information is displayed, as determined at 504, then the process next determines (at 506) whether the presented information has changed. If the presentation of the information has changed, the process generates (at 508) presentation data. The presentation data generated at 508 can be stored and transmitted (such as to the analysis device 114 of FIG. 1).

As discussed above, the presentation data can include one or more of the following: an indicator of a zoom level at which the information is viewed, an indicator of a location of the information on a display of the electronic device, an indicator relating to a length of time during which the information is being presented, an indicator relating to how much of the display of the electronic device is presenting the information, an indicator relating to how much of the information is being presented on the display, an indicator of rendered resolution, an indicator of the displayable resolution, and so forth

Whether the presented information has changed may be based on any number of factors, including for example: the information was previously not displayed but is now displayed, or vice versa (due to user selections or other events that cause windows to appear or be minimized, or that cause windows to move, etc.); a zoom level has changed (due to a user making a selection to zoom in or zoom out or an application automatically causing a zoom action); a location of the information has changed (due to a user making a selection to scroll or an application automatically causing movement of the information); and so forth.

As an example, a web page containing a rectangular banner advertisement may initially be displayed at a zoom level of 100%, with the top-left corner of the advertisement at a first location. The presentation of the web page may be changed by scrolling in any direction or zooming in or out to any level. When the device detects that the presentation of the web page has been scrolled or zoomed, the device may then generate one or more indicators related to the advertisement.

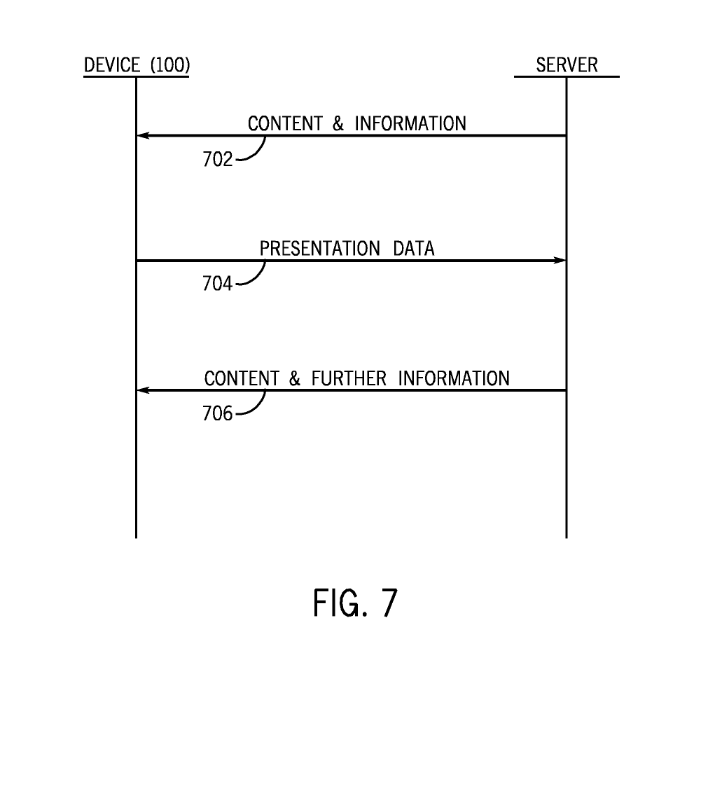

FIG. 6 is a flow diagram of a process of an information server (e.g. 332 or 324), in accordance with some embodiments. The information server sends (at 602) information, such as an advertisement, to at least one electronic device 100. Next, the information server 200 receives (at 604) presentation data, which can include various indicators as discussed above.

The information server further receives and stores (at 606) effectiveness measure(s) (such as 132 in FIG. 1) related to the presentation data. The analysis effectiveness measure(s) may be generated by the presentation data analysis module 128 (FIG. 1) executable in the information server, in the electronic device, or on another device (e.g. mobility server 314 or content server 322 in FIG. 3).

The information server sends (at 608) further information based at least in part on the effectiveness measure(s). For example, the effectiveness measure(s) can indicate a relatively high effectiveness of the information sent at 602, such as in response to the presentation data indicating that the information was presented at a relatively high zoom level, the information was displayed in the middle of a display, the information occupied a relatively large percentage of the display, and a relatively large portion of the information was displayed. In contrast, the effectiveness measure(s) can indicate a relatively low effectiveness of the information sent at 602, such as in response to the presentation data indicating that the information was displayed at a relatively low zoom level, the information was displayed at an edge of a display, the information occupied a relatively small percentage of the display, and a relatively low percentage of the information was displayed. Based on the effectiveness measure(s) indicating that the information sent at 602 is relatively effective, the further information sent at 608 can be a duplicate of the information sent at 602, or can be related to the information sent at 602. For example, advertisement indicated as being relatively effective can be repeatedly sent by the information server to electronic device(s), whereas the information server can avoid or reduce sending of advertisement indicated as having low effectiveness.

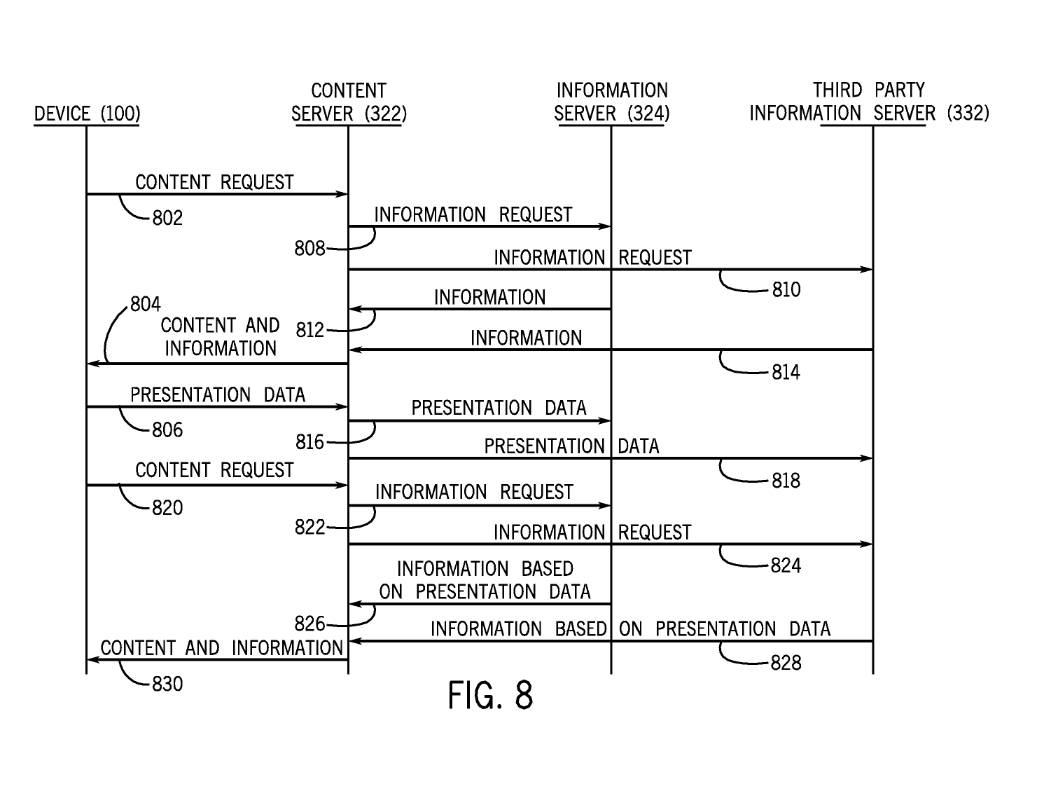

FIG. 7 is a data flow diagram illustrating communication between the electronic device 100 and a server (e.g. the information server 332 or 324, the content provider 322, or the mobility server 314) in accordance with some embodiments. Information, such as an advertisement, is sent (at 702) by the server to the electronic device 100, along with content (e.g. web page).

The electronic device 100 sends (at 704) presentation data in response to the information received from the server. The electronic device 100 may consolidate a plurality of presentation data that is to be sent into one message. For example, the electronic device 100 may consolidate a plurality of presentation data collected over a fixed period of time, e.g. 24 hours, and send the plurality of presentation data during some predetermined time interval e.g., during off-peak hours. Alternatively, every time the presentation data at the electronic device 100 changes, the electronic device 100 can send the changed presentation data to the server.

The server sends (at 706) further information to the electronic device 100 according to an analysis of the presentation data received from the electronic device. The analysis of the presentation data can be performed at the server, or at another device.

FIG. 8 is a flow diagram of communication among various nodes, including the electronic device 100 and the content server 322, information server 324, and third party information server 332, in accordance with further embodiments. The electronic device 100 sends (at 802) a content request to the content server 322. The content request may be a request for any one or combination of data (e.g. a web page), applications (e.g. a gaming application), services (e.g. navigation service), and so forth. The electronic device 100 receives a content response at 804 from the content server 322. The content response may include at least part of the content requested and information (e.g. advertisement) in addition to the content that was requested. The electronic device 100 sends (at 806) presentation data to content server 322 that pertains to the content and information received at 804. Alternatively, the electronic device 100 may also send presentation data to the information server 324 and the third party information server 332 (not shown).

In response to the content request (802) from the electronic device 100, the content server 322 can send (at 808, 810) information request(s) to one or more of the information server 324 and third party information server 332. In the ensuing discussion, it is assumed that the content server 322 sent the information requests (808 and 810) to both information servers 324 and 332 (in alternative examples, the content server 322 can send an information request to just one of the information server 324 or 332). The content server 322 can receive (at 812) an information response from the information server 324 and receive (at 814) an information response from the third party information server 332. Each information response may include information such as an advertisement to be displayed with content. Additionally or alternatively, the information response may include an indicator, reference, or link to the information requested. The response sent (at 804) from the content server 322 to the electronic device 100 can include the information received from the information server 324 or 332, or both.

In response to the presentation data (806) from the electronic device 100, the content server 322 can perform analysis of the presentation data at the content server 322. Additionally or alternatively, the content server 322 can forward the presentation data (816, 818) to one or both of the information servers 324 and 332, for analysis at the information server(s). The analysis of the presentation data results in effectiveness measure(s) relating to display of information from the information server 324 or 332 (or both) at the electronic device 100.

The electronic device 100 can send (at 820) a second content request to the content server 322. In response to the second content request, the content server 322 can send (at 822, 824) information request(s) to one or both of the information servers 324, 332. The content server 322 receives (at 826, 828) information response(s) from one or both of the information servers 324, 332.

The content server 322 sends (at 830) a second content response (including requested content along with information from the information server 324 or 332, or both) to the electronic device 100, which is responsive to the second content request (820). The information sent in the second content response may be based on an analysis of the presentation data that was performed by any of the content server 322, information server 324, or information server 332. For example, if the information sent at 830 includes advertisement information, then the advertisement information sent at 830 can be based on a determination of an effectiveness of previous advertisement information sent (such as at 804). The advertisement information to be sent (at 830) by the content server 322 to the electronic device 100 can be selected by the content server 322 based on the effectiveness measure(s) computed at the content server 322 (or received from the information server 324 or 332), or by the information server 324 or 332 based on the effectiveness measure(s) computed at the information server 324 or 332.

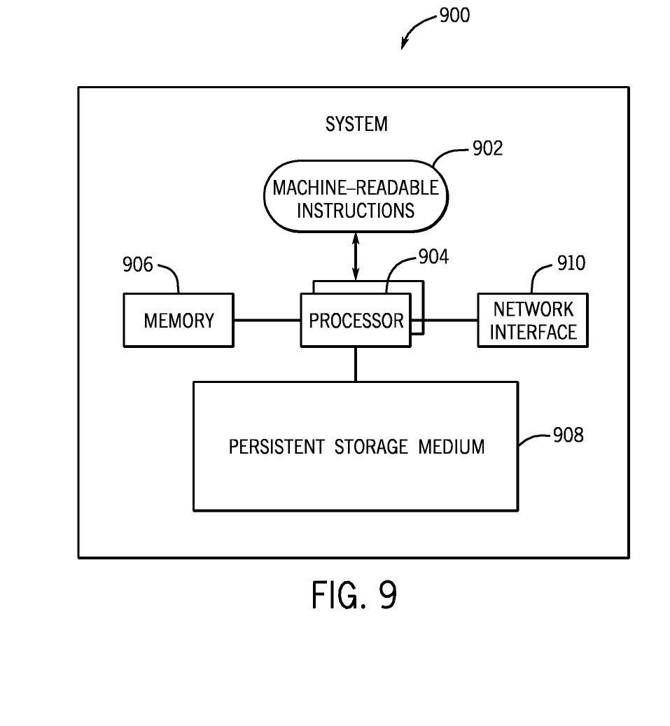

FIG. 9 is a block diagram of a system 900 according to some examples, where the system can represent any of the following: electronic device 100, 306, or 308; analysis device 114, mobility server 314, information server 324 or 332; or content server 322. The system 900 includes machine-readable instructions 902, which can be any of the various modules described above (viewing application 122, presentation data tracker 122, or presentation data analysis module 128 in FIG. 1) or any other module.

The machine-readable instructions are executable on one or multiple processors 904, which can be connected to a memory 906, a persistent storage medium 908, and a network interface 910 (to communicate over a wired or wireless network). A processor can include a microprocessor, microcontroller, processor module or subsystem, programmable integrated circuit, programmable gate array, or another control or computing device.

The storage medium 908 or memory 906 (or both) can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of a system having a processor, comprising:
receiving, from an electronic device over a network, presentation data related to presentation of information at the electronic device, wherein the presentation data comprises a first indicator of a zoom level at which the information was presented; and
storing an effectiveness measure relating to an analysis of the presentation data to indicate an effectiveness of the presented information.

2. The method of claim 1, wherein receiving the presentation data related to the presentation of information at the electronic device comprises receiving the presentation data that is based on user actions relating to the presented information.

3. The method of claim 2, wherein receiving the presentation data that is based on user actions relating to the presented information comprises receiving the presentation data that is based on scrolling or zoom actions of a user.

4. The method of claim 1, wherein receiving the presentation data comprises receiving presentation data that contains a further indicator selected from the group consisting of: an indicator of a location of the information on a display of the electronic device, an indicator relating to a length of time during which the information was presented, an indicator relating to how much of the display of the electronic device was presenting the information, an indicator relating to how much of the information was being presented on the display, an indicator of a rendered resolution, and an indicator of a displayable resolution.

5. The method of claim 1, further comprising analyzing, by the processor, the presentation data to derive the effectiveness measure.

6. The method of claim 1, further comprising:
sending the presentation data to an analysis device to derive the effectiveness measure; and
receiving the effectiveness measure from the analysis device.

7. The method of claim 1, further comprising determining an amount to bill a third party based on the effectiveness measure.

8. The method of claim 1, further comprising determining further information to send to the electronic device based on the effectiveness measure.

9. The method of claim 1, wherein the effectiveness measure includes a value of the presented information or a priority of the presented information.

10. A method of an electronic device comprising:
presenting information for display at the electronic device; and
sending, to an analysis device, presentation data related to the presentation of the information, the presentation data comprising a first indicator of a zoom level at which the presented information was displayed and a second indicator of a time duration at which the presented information was displayed at the zoom level.

11. The method of claim 10, further comprising:
receiving a command to change the presentation of the information;
changing the zoom level based on the command; and
updating the presentation data based on the change in zoom level.

12. The method of claim 10, wherein sending the presentation data further comprises sending presentation data that contains a further indicator selected from the group consisting of: an indicator of a location of the information on a display of the electronic device, an indicator relating to how much of the display of the electronic device was presenting the information, an indicator relating to how much of the information was being presented on the display, an indicator of a rendered resolution, and an indicator of a displayable resolution.

13. The method of claim 12, wherein the further indicator is related to the first and second indicators, so as to relate the time duration at which the presented information was displayed at the zoom level to a further characteristic indicated by the further indicator.

14. The method of claim 10, further comprising receiving second information sent based on the presentation data.

15. The method of claim 10, wherein presenting the information comprises presenting an advertisement.

16. A system comprising:
an interface to communicate over a network; and
at least one processor configured to:
receive, from an electronic device over the network, presentation data related to presentation of information at the electronic device, wherein the presentation data comprises a first indicator of a zoom level at which the information was presented at the electronic device, and a second indicator of a time duration at which the presented information was displayed at the zoom level.

17. The system of claim 16, wherein the at least one processor is to further store an effectiveness measure relating to an analysis of the presentation data to indicate an effectiveness of the presented information.

18. The system of claim 16, wherein the presentation data further comprises a further indicator selected from the group consisting of: an indicator of a location of the information on a display of the electronic device, an indicator relating to how much of the display of the electronic device was presenting the information, an indicator relating to how much of the information was being presented on the display, an indicator of a rendered resolution, and an indicator of a displayable resolution.

19. The system of claim 16, wherein the presentation data is based on user actions relating to the presented information at the electronic device.

20. The system of claim 19, wherein the presentation data that is based on user actions relating to the presented information comprises presentation data that is based on scrolling or zoom actions of a user.
